(19) United States
(12) Patent Application Publication
(10) Pub. No.: US 2007/0105744 A1
(43) Pub. Date: May 10, 2007

(54) Water-softening product

(75) Inventor: Fabio Amiconi, Carbonera (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/555,859

(22) PCT Filed: May 7, 2004
(86) PCT No.: PCT/GB04/01963

§ 371 Date: Nov. 17, 2006

(30) Foreign Application Priority Data
May 10, 2003 (GB) 0310803.2

(51) Int. Cl. C11D 3/00

(52) U.S. Cl. 510/515; 510/315

(57) ABSTRACT

A liquid water-softening composition comprising: a) at least one water-softening active; and b) an organic solvent; said composition containing less than 35 wt % water.

The present invention relates to liquid water-softening compositions, especially compositions which dissolve and disperse satisfactorily in water.

Water softening products are sold commercially (such as the product Calgon®) and are used to aid detergency and prevent the build up of scale in the washing machine and on clothes, such products are described in EP-A1-0 628 627 (Benckiser), CH-577 937 (Lonza), WO-A1-95/21908 (Henkel) and EP-A2-0 622 449 (Huls).

The use of water-softening polymer polycarboxylates in detergent formulas has provided multiple benefits such as calcium sequestration, crystal growth inhibition to minimize encrustation on fabrics, lime soap dispersancy, and particulate soil dispersion. Sequestration of “hardness” metal-ions such as calcium and magnesium by the polycarboxylates softens the water and increases detergency. Also sequestration of hardness ions by the polycarboxylates prevents the precipitation of salts of anionic surfactants, which if allowed to occur will lead to reduced detergency. Dispersion of particulate soil such as clay by the polycarboxylates prevents the redeposition of soils on the fabric.

Conveniently it would be preferred that water-softening products could be added to the washing machine as a liquid rather than as a solid product. Also it is preferable that the product has a viscosity which is greater than that of water.

Liquid water-softening compositions often contain up to 80 wt % water. Such compositions do not generally have any compatibility problems when being diluted with a large quantity of water.

GB2379214 describes an aqueous based water-softening composition thickened with xanthan gum.

Conveniently, it is preferred that such liquid water-softening products are added to the washing machine as convenient unit doses, encapsulated in a water-soluble polymer.

The invention relates to compositions in the form of a viscous composition, which is substantially free of water that contains water softening agents. Preferably the composition is transparent. The composition is highly concentrated with water softening actives incorporated by the use of solvents and has been specially developed with a low amount of water for encapsulation in water soluble packaging made of a water-soluble polymer, such as poly (vinylalcohol) [PVOH], cellulose, (HPMC), or gelatin, that dissolve easily in water.

Additional problems are to disperse and bring in solution during manufacture of the compositions a high amount of actives, in powder form, in a low amount of water and obtain a stable composition without any precipitation. The objective is achieved by producing a water softener composition in gel form containing a low amount of water by the use organic solvents and a water-softening active that is preferably acidic, ideally containing at least one carboxylic acid, a part neutralised acid polymer with an organic alkaline agent as the neutralising agent.

Accordingly the present invention provides a liquid water-softening composition comprising:
a) at least one water-softening active; and
b) at least one organic solvent;
   said composition containing less than 35 wt %, ideally less than 25 wt %, preferably less than 18 wt %, 15 wt %, 10 wt %, 5 wt %, or 1 wt % of water.

Ideally the composition is transparent.

Larger amounts of water can be found in the composition which is chemically or physically bound. Therefore, the amount of water is preferably less than 35 wt %, or 25 wt %, ideally less than 18 wt %, preferably less than 15 wt %, 10 wt %, 5 wt %, 1 wt % of free water. Preferably the composition is anhydrous. By free water we mean water that is not physically or chemically bound.

The formulation may be diluted by the addition of further amounts of water of up to an additional 20, 30, 40 or 50 wt % of water.

There is no direct correlation between the actual amount of water present in a composition and the amount of free water present. Free water does not include water which is not available such as water held within a gelled matrix or water of salvation of any components present in the composition.

In order to determine the amount of free water present in a composition, a standard loss-on-drying determination test may be carried out. A sample of the composition, usually about 10 g, is weighed, and then maintained at 60° C. for 3 hours under a partial vacuum of 200 mbar (20 kPa). The sample is then re-weighed, and the weight lost determined.

The composition preferably comprises water softening actives that are soluble in polar solvents.

Preferably the water-softening active is an acid. Preferably the acid is a carboxylic acid.

Preferably, the water-softening active is a water-softening polymer. By the use of the phrase “a water-softening polymer” we mean polycarboxylic acid polymers, preferably polyacrylic polymers, based on acrylic acid combined with or without other moieties. These include acrylic acid combined with; maleic acid (such as Sokalan CPS and CP7 supplied by BASF or Acusol 479N supplied by Rohm & Haas); methacrylic acid (such as Colloid 226/35 supplied by Rhone-Poulenc); phosphonate (such as Casi 773 supplied by Buckman Laboratories); maleic acid and vinyl acetate (such as polymers supplied by Huls); acrylamide; sulfophenol methallyl ether (such as Aquatreat AR 540 supplied by Alco); 2 -acrylamido-2 -methylpropane sulfonic acid (such as Acumer 3100 supplied by Rohm & Haas or such as K-775 supplied by Goodrich); 2 -acrylamido-2 -methylpropane sulfonic acid and sodium styrene sulfonate (such as K-798 supplied by Goodrich); methyl methacrylate; sodium methallyl sulfonate and sulfophenol methallyl ether (such as Alcoperse 240 supplied by Alco); polymaleates (such as Belclene 200 supplied by FMC); polymethacrylates (such as Tamol 850 from Rohm & Haas); polyaspartates or ethylenediamine disuccinate and organo polyphosphonic acids and their salts such as the sodium salts of aminotri (methylenephosphonic acid) and ethane 1 -hydroxy-1,1-diphosphonic acid.

Preferably the polymer is a homopolymer of acrylic acid, blended with or without a polymaleic acid polymer or a polyacrylic/polymaleic acid copolymer. Preferably the polymer is a homopolymer of acrylic acid (such as those sold by Rohm & Haas under the Acusol trademark, such as Acusol WE).

Preferably, the water-softening polymer is partly neutralised. The term “partly neutralised” excludes neutralisation of more than 90% of the free acid (ideally carboxy) groups. We have found that if the polymer is added as a granulate into the composition then it is preferable for the granulometry to be “small” to improve manufacture, aesthetics and stability. By small we mean that at least 60% of the particles are 210 microns or less. Typically such polymer granules are prepared by spray drying processes, as opposed to fluid bed drying where larger particle sizes are produced.

In a feature of the invention the water-softening polymer is partly neutralised with an organic base, preferably a C₁₋₁₆ alkanolamine (preferably a trialkanolamine). A preferred alkanol is ethanol. Preferred amounts are up to 15 wt %. Under such circumstances, neutralisation, certain polymer, based upon carboxy groups, may also thicken the composition.

Preferably the average MW (Mw) of the water-softening polymer should be greater than 1,000, ideally greater than 2,000, based upon the free acid.

Additional water-softening agents may be added to the composition. Preferably the additional water softening agent is a water-soluble water softening agent, which is organic monomeric polycarboxylic acids and their salts (such as citrates, gluconates, oxydisuccinates, glycerol mono- di- and trisuccinates, carboxymethyloxysuccinates, carboxymethyloxymalonates, dipicolinates and hydroxyethyliminodiacetates); sequestering agents (such as phosphonates and iminodisuccinates); radical scavengers (such as BHT); phosphonates (such as diethylenetriaminepenta (methylene phosphonic acid) and its corresponding pentasodium salt, (available under the trade names Dequest 2060 and Dequest 2066 Monsanto Chemical Co.), DTPMP and DTPMA).

Preferably the composition of the invention comprises at least two water-softening actives, ideally at least one water-softening polymer and at least one monomenic polycarboxylic acid, preferably citric acid or a salt thereof.

Inorganic water-soluble water softening agents that may be present include alkali metal (generally sodium) carbonate.

Water-softening agents that are not soluble in polar solvents may also be present. They may be suspended in the solvent or may form a paste or a mull, if larger amounts are included. Preferably, they are present only at levels of up to 50% wt, 40% wt, 30% wt, 20% wt, 10% wt, 5% wt. Suitable examples include hydrominerals, such as zeolite, clay or any other suitable silicate.

The presence of surfactant and/or a source of active oxygen is not excluded from this invention. This invention may find use in the preparation of viscose detergent liquid compositions that contain a water-softening active and low amounts of water. Preferably the composition contains less than 20% wt, 15% wt, 10% wt or 5% wt, ideally less than 1% wt, of a surfactant.

The composition of the present invention may contain surfactants such as anionic, nonionic, amphoteric, cationic or zwitterionic surfactants, or a mixture thereof.

The composition, either encapsulated in a water-soluble polymer or not, can be used in fabric washing(washing machines or hand washing) jointly with a detergent composition. Other applications, in machine dish washing as anti lime scale product or as anti lime scale product in general for hard surfaces are also possible.

Organic solvents may be added to replace the water. suitable organic solvents include C3 -C12 alkyl glycol, C3 -C12 alkylglycol ethers and C1 -C4 alcohols, such as methanol, ethanol and isopropanol. The solvent is typically present in an amount from 0.5 wt % to 80 wt %, preferably from 10 wt % to 70 wt %, ideally from 20 wt % to 55 wt %, and most preferably from about 35 wt % to 50 wt % by weight of the composition.

The organic solvent may be any organic solvent, although it is desirable that it is miscible with water. Examples of organic solvents are glycols, glycerine or an alcohol. Preferred organic solvents are C₁₋₄ alcohols such as ethanol or propanol, and C₂₋₄ glycols such as monoethylene glycol and monopropylene glycol. Additional solvents include polyethylene glycols (PEG200, PEG400 and PEG600 ).

The pH is measured as 5% wt solutions in deionised water at 20° C. For optimum stability of these compositions, the pH, measured in the above-mentioned conditions, must be in the range of less than 9, 8 or 7, or from 2.0 to 7.0, ideally from 4.0 to 6.0 or 4.5 to 6.5, especially 5.0 to 5.7. The pH of these compositions can be regulated by the addition of a Bronsted acid or base. Preferably the composition is neutalised with a base, since the preferred water softening actives are typically acidic. Preferably an organic base is used. Suitable organic bases are added as organic amines, i.e. alcohol amines, mono-, di-, tri- (or a mixture thereof) ethanolamine. Preferably only up to 15 wt % of a base is added.

The composition of the present invention contains less than 3 wt % of water, preferably of free water. Desirably the composition contains less than 2 wt % water, even more desirably less than 1 wt % water, preferably of free water. Most preferably, the composition is substantially anhydrous. It will be appreciated that higher water content could be included when it is chemically or physically bound.

The present composition is especially suitable for use in a water-soluble container where the container is simply added to a large quantity of water and dissolves, releasing its contents. The favourable dissolution and dispersion properties of the composition of the present invention are particularly useful in this context.

Thus the present invention also provides a water-soluble container containing a composition as defined above.

A further feature of the invention is a method of softening water during a fabric washing process the method comprising adding a composition or container as defined herein to the fabric wash or rinse liquor.

The water-soluble container may comprise a thermo formed or injection moulded water-soluble polymer. It may also simply comprise a water-soluble film. Such containers are described, for example, in EP-A-524,721, GB-A-2,244,258, WO 92/17,381 and WO 00/55,068.

In all cases, the polymer is formed into a container such as a pouch which can receive the composition, which is filled with the composition and then sealed, for example by heat sealing along the top of the container in vertical form-fill-processes or by laying a further sheet of water-soluble polymer or moulded polymer on top of the container and sealing it to the body of the container, for example by heat sealing.

Desirably the water-soluble polymer is a poly (vinyl alcohol) (PVOH). The PVOH may be partially or fully alcoholised or hydrolysed. For example, it may be from 40 to 100% preferably 70 to 92%, more preferably about 88%, alcoholised or hydrolysed, polyvinyl acetate. When the polymer is in film form, the film may be cast, blown or extruded.

The water-soluble polymer is generally cold water (20° C.) soluble, but depending on its chemical nature, for example the degree of hydrolysis of the PVOH, may be insoluble in cold water at 20° C., and only become soluble in warm water or hot water having a temperature of, for example, 30° C., 40 C, 50° C. or even 60° C. Because the composition contains less than 35 wt % water, preferably less than 35 wt % of free water, the composition should not attack the PVOH container. However, if larger amounts of water are present, either as free water or as total water, it is preferable to include electrolyte into the composition to increase the ionic strength of the composition and protect the PVOH container, such technique is taught in EP0519689. Suitable electrolytes are metal salts that freely dissociate upon dissolution, such as salts of alkali or alkaline earth metals. Amounts of electrolyte present may be up to 50 wt %, 40 wt %, 30 wt %, 20 wt % or 10 wt %.

The containers of the present invention find particular use where a unit-dosage form of the composition is required. The use of the container may place restrictions on its size. Thus, for example, a suitable size for a container to be used in a laundry or dish washing machine is a rounded cuboid container having a length of 1 to 5 cm,.especially 3.5 to 4.5 cm, a width of 1.5 to 3.5 cm, especially 2 to 3 cm, and a height of 1 to 2 cm, especially 1.25 to 1.75 cm. The container may hold, for example, from 10 to 40 g of the composition, especially from 15, 20 or 30 to 40 g of the composition for laundry use or from 15 to 20 g of the composition for dishwashing use.

Process for preparing suitable water-soluble containers are described in W00136290 and W00216207.

The viscosity of the composition of the present invention, measured using a Brookfield viscometer, model DV-II+, with spindle S31 at 12 RPM and at 20° C., is desirably 500 to 1,000,000 cps, more especially 1500 to 500,000 cps, especially 10,000 to 40,000 cps.

The present invention is now further described in the following Examples, in which all of the parts are parts by weight.

| RAW | % AC- | | | | | | | | | | | | | | |
|---|---|---|---|---|---|---|---|---|---|---|---|---|---|---|---|
| MATERIALS | TIVES | 1 | 2 | 3 | 4 | 5 | 6 | 7 | 8 | 9 | 10 | 11 | 12 | 13 | 14 |
| H₂O | | | 0.47 | 2.47 | 4 | 8.87 | 8.87 | 8.87 | 10 | 8.87 | 8.87 | 14 | 30 | 58 | 70 |
| Colour | 1 | | 0.4 | 0.4 | 0.4 | 0.4 | 0.4 | 0.4 | 0.4 | 0.4 | 0.4 | 0.38 | 0.4 | 0.4 | 0.4 |
| Sequion 10Na | 92 | | 0.4 | 0.4 | 0.4 | 0.4 | 0.4 | 0.4 | 0.4 | 0.4 | 0.4 | 0.38 | 0.4 | 0.4 | 0.4 |
| Glycerine | | 13.4 | 13 | 12 | 12 | 10 | 10 | 12.2 | 10 | 10 | 10 | 9.52 | 6 | | |
| PEG 400 | | 14.8 | 12.4 | 11.4 | 10.7 | 9.2 | 9 | 11.4 | 14.2 | 9.2 | 2 | 8.76 | 4.37 | | |
| Monopropylene | | 20.3 | 20.5 | 20.5 | 19.67 | 18.3 | 18 | 20.5 | 20 | 12.3 | 2 | 16.64 | 6 | | |
| glycol | | | | | | | | | | | | | | | |
| Citric Acid | | 15 | 15 | 15 | 15 | 15 | 15 | 15 | 5 | 15 | 15 | 14.29 | 15 | 15 | 8 |
| Acusol WE | 92 | 25 | 25 | 25 | 25 | 25 | 25 | 25 | 40 | 25 | 25 | 23.81 | 25 | 25 | 20 |
| Monoethanol | 99 | 11.5 | 11.5 | 11.5 | 11.5 | 11.5 | 11.5 | 4.9 | | 17.5 | 35 | 10.95 | 11.5 | | |
| amine | | | | | | | | | | | | | | | |
| Sodium | 15 | | 1.33 | 1.33 | 1.33 | 1.33 | 1.33 | 1.330 | | 1.33 | 1.33 | 1.27 | 1.33 | 1.2 | 1.2 |
| Sulphite | | | | | | | | | | | | | | | |
| Zeolite | | | | | | | 0.5 | | | | | | | | |
| TOTAL | | 100 | 100 | 100 | 100 | 100 | 100 | 100 | 100 | 100 | 100 | 100 | 100 | 100 | 100 |

1. A liquid water-softening composition comprising:
a) at least one water-softening active; and
b) an organic solvent;
said composition containing less than 35 wt % water.

2. A composition according to claim 1 wherein the at least one water-softening active is an acid.

3. A composition according to claim 1 wherein the at least one water-softening active is a carboxylic acid.

4. A composition according to claim 2 wherein the acid is partly neutralised.

5. A composition according to claim 1 wherein at least one water-softening active is a water-softening polymer.

6. A composition according to claim 5 wherein the water-softening polymer is a polycarboxylic acid polymer.

7. A composition according to claim 6 wherein the polycarboxylic acid polymer is a polyacrylic polymer.

8. A composition according to claim 1 wherein the acid water-softening active is partly neutralised by an organic base.

9. A composition according to claim 8 wherein the acid water-softening active that is neutralised is citric acid.

10. A composition according to claim 8 wherein the organic base is an alkanolamine.

11. A composition according to claim 10 in which the alkanolamine is monoethanolamine, diethanolamine or triethanolamine.

12. A composition according to claim 1 wherein the organic solvent is a glycol, glycolether glycerine, or an alcohol or a mixture thereof.

13. A composition according to claim 12 wherein the organic solvent is polyethylene glycol, glycerine, monopropylene glycol or ethanol.

14. A composition according to claim 1 which contains less than 15 wt % of free water.

15. A composition according to claim 1 wherein the composition is anhydrous.

16. A composition according to claim 1 which comprises from 10 to 70 wt % of organic solvent.

17. A composition according to claim 1 which has a pH when measured as a 5% wt solution in deionised water at 20° C. of less than 9.

18. A composition according to claim 1 which contains a monomeric polycarboxylic acid.

19. A composition according to claim 1 which has a viscosity of 500 to 1,000,000 cps measured using a Brookfield viscometer with spindle S31 at 12 RPM and 20° C.

20. A composition according to claim 18 wherein the monomeric polycarboxylic acid is citric acid.

21. A water-soluble container containing a composition according to claim 1.

22. A water-soluble container containing a liquid water-softening composition comprising:
a) at least one water-softening active;
b) an organic solvent;
c) an electrolyte; and
said composition containing greater than 35 wt % water.

23. A container according to claim 19 which comprises a thermoformed or injection moulded water-soluble polymer.

24. A container according to claim 21 wherein the water-soluble polymer is a poly (vinyl alcohol) or gelatin.
